(19) United States
(12) Patent Application Publication
(10) Pub. No.: US 2019/0288964 A1
(43) Pub. Date: Sep. 19, 2019

(54) Processing Combined Multi-Source Data Streams

(71) Applicant: International Business Machines Corporation, Armonk, NY (US)

(72) Inventors: JONATHAN DUNNE, Dungarvan (IE); Anat Hashavit, Haifa (IL); Amir Nissan Cohen, Haifa (IL); Naama Tepper Naama Tepper, Koranit (IL)

(21) Appl. No.: 15/881,824

(22) Filed: Mar. 15, 2018

(51) Int. Cl. H04L 12/58; H04L 12/24

(52) U.S. Cl. CPC H04L 51/04; H04L 67/306; H04L 41/145

(57) ABSTRACT

Configuring a data output stream based on combined multi-source data streams by a) processing data from one or more data stream collators in accordance with predefined data pre-processing procedures, where the data are known to be associated with a given data stream source, b) processing the data using data group identification procedures to derive a data group distribution for the data stream source, c) processing the data using data segmentation procedures that relate to a data segmentation model, d) processing the data using data stream network identification procedures to identify network connections between data stream sources that are associated with the data, and to construct a model of the network connections, e) deriving, from output of any of steps b), c), and d), values for one or more attributes associated with the data stream source, and configuring a data output stream based on the attributes and the attribute values.

### BACKGROUND

Multi-source collections of data, such as on-line chat rooms, are not typically limited by number of users or time zones, and multiple data streams that are relevant to a particular data consumer can occur in parallel or even when the data consumer is offline. Consumers of data from multiple data streams can easily be faced with data overload. While data management tools and techniques are available for managing such collated, multi-source data, challenges still remain, such as when working with unstructured data.

### SUMMARY

In one aspect of the invention a method is provided for configuring a data output stream based on combined multi-source data streams, the method including in a step a), processing combined multi-source data stream data from one or more data stream collators in accordance with predefined data transformation procedures, where the data are known to be associated with a given data stream source in a step b), processing the combined multi-source data stream data in accordance with predefined data group identification procedures to derive a data group distribution for the given data stream source in a step c), processing the combined multi-source data stream data in accordance with predefined data segmentation procedures that relate to a data segmentation model in a step d), processing the combined multi-source data stream data in accordance with predefined data stream network identification procedures to identify network connections between data stream sources that are associated with the combined multi-source data stream data, and to construct a data stream source network model in a step e), deriving, from output of any of steps b), c), and d), values for one or more attributes associated with the data stream source, and configuring a data output stream to the data stream source in accordance with any of the attributes and the derived attribute values associated with the data stream source.

In other aspects of the invention systems and computer program products embodying the invention are provided.

### BRIEF DESCRIPTION OF THE DRAWINGS

Aspects of the invention will be understood and appreciated more fully from the following detailed description taken in conjunction with the appended drawings in which:

FIG. 1 is a simplified conceptual illustration of a system for processing combined multi-source data streams, constructed and operative in accordance with an embodiment of the invention;

FIG. 2 is a simplified flowchart illustration of an exemplary method of operation of the system of FIG. 1, operative in accordance with an embodiment of the invention; and

FIG. 3 is a simplified block diagram illustration of an exemplary hardware implementation of a computing system, constructed and operative in accordance with an embodiment of the invention.

### DETAILED DESCRIPTION

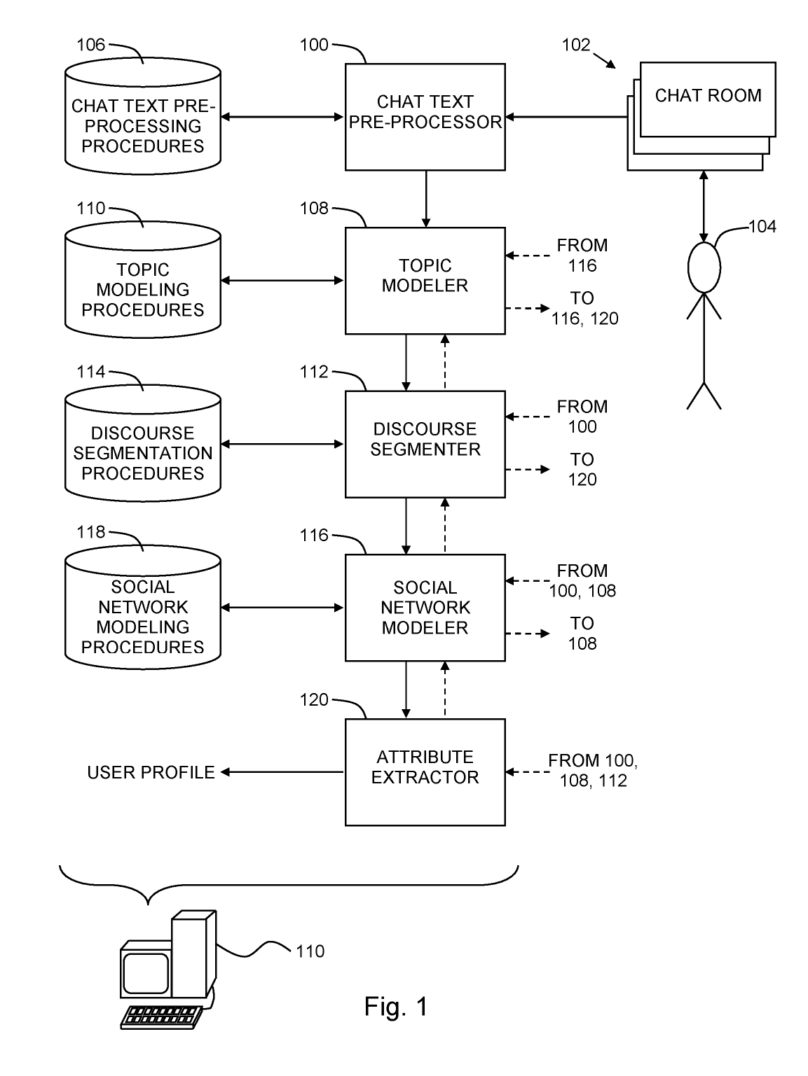

Reference is now made to FIG. 1, which is a simplified conceptual illustration of a system for processing combined multi-source data streams, constructed and operative in accordance with an embodiment of the invention. In the system of FIG. 1, a data pre-processor 100 is configured to process data from one or more data stream collators 102, where the data are known to be associated with a given data stream source 104. Data stream source 104 may be any source of data communications, such as a computer or a computer user, where the term “data stream” refers to a series of such data communications from the source over a period of time. Data stream collators 102 may be any data storage device to which such data communications are directed, or any physical or logical repository of data that may be stored on a data storage device and that stores such data communications, such as a data file or a chat room. Data pre-processor 100 preferably processes the data in accordance with predefined data transformation procedures 106. Data transformation procedures 106 may include any method for pre-processing the data, such as any of the following: aggregating data streams from, to, or otherwise associated with data stream source 104 into a single data stream; removing system messages, including notifications that a data stream source has connected to, or disconnected from, a data stream collator; removing predefined stop words or other extraneous elements such as emojis, giphys, slang, and typos; crawling hyperlinks within the data and replacing the hyperlinks with URL titles, content, or summaries derived from the crawled hyperlinks; and splitting any portion of the data into n-gram tokens in accordance with a predefined n-gram model.

A data group identification manager 108 processes the data in accordance with predefined data group identification procedures 110 to derive a data group distribution for data stream source 104. Data group identification procedures 110 may include any method for deriving data group distribution from the data, such as Latent Dirichlet Allocation, where data groups are expressed as topics, or Chinese Restaurant Process-based hierarchical data group (e.g., topic) modeling.

A data segmenter 112 processes the data in accordance with predefined data segmentation procedures 114 which may relate to any data segmentation model. In one embodiment, data segmenter 112 uses the data group distribution produced by data group identification manager 108 for one or more data stream sources, as well as known network connections between the data stream sources, and assumes that each type of data segment (e.g., discourse) relates to a single data group and that data stream sources that are members of the same network, particularly social networks, tend to participate in the same discourses together.

A data stream network identification manager 116 processes the data in accordance with predefined data stream network identification procedures 118 to identify network connections between data stream sources that are associated with the data and construct a model of those network connections. Data stream network identification manager 116 preferably represents each data stream source as a vertex in a graph, where an edge from data stream source i to data stream source j represents a network connection between the two data stream sources. Data stream network identification procedures 118 may include any method for identifying data stream source network connections, such as any of the following: determining that data stream source i was identified in data stream source j or that data stream source j was identified in data stream source i; determining that data stream sources i and j both participated in a shared data communication; identifying communications from data stream source i in response to communications from to data stream source j or from data stream source j in response to data stream source i, as well as the elapsed time between responses; identifying similarities in data group identifiers between different data stream sources, such as by determining cosine similarity between data group distribution vectors of different data stream sources; and identifying data stream source identification variants used by one data stream source to identify another data stream source. In one embodiment data stream network identification manager 116 derives a probabilistic model of data stream source identification variants based which data stream sources responded to communications from other data stream sources, and which identifier variants were used in such communications to identify the data stream sources. For example: <Data Source X, Sensor123>0.8, <Data Source X, HeatSensor, 0.6>, <Data Source X, TempMonitor, 0.9>. Data stream network identification procedures 118 may include any method for modelling identified data stream source network connections. Data stream network identification manager 116 creates a weighted directed graph whose vertices represent data stream sources or groups of data stream sources and whose edges represent types and strength of connections between data stream sources. In one embodiment, edge weight is determined based on different connection types, such as by aggregating values based on a linear combination of explicit or inferred inclusion of specific data in data streams, data group similarity, and number of joint participation in shared data communications, such as in a chat room. In another embodiment, data stream sources are connected using different edge types that represent different types of connection, such as, for example, network affinity, common data groups, and manager-subordinate relationships. In one embodiment, edge weight is determined to represent the strength of the connection or the level of confidence of the connection.

In various embodiments shown using dashed lines, any of data group identification manager 108, data segmenter 112, and data stream network identification manager 116 receives as input, and is configured to process, the output of data pre-processor 100, and/or the output of any of their counterparts.

As was mentioned above, Latent Dirichlet Allocation can be used by data group identification manager 108 to process data stream data, although many alternative techniques can be used. Data segmenter 112 may use data segmentation techniques such as are described by Joty, Carenini, & Ng, 2013; Mu, Stegmann, Mayfield, Rosé, & Fischer, 2012; Zhai & Williams, 2014; and Nguyen, Boyd-Graber, & Resnik, 2012. Data stream network identification manager 116 may use techniques described by Tuulos & Tirri, 2004, specifically for labelling popular data stream sources, community detection, identifying network roles, including in data communications networks that have a social aspect (e.g., social networks), and data source (e.g., author) characterization.

For each step of the processing described above, any of the data described herein are preferably input into each analysis component (i.e., data group identification manager 108, data segmenter 112, and data stream network identification manager 116) in the form of a pipeline. When each successive analysis output is obtained, this result is chained to each additional output to provide a successive number of outputs.

An attribute extractor 120 is configured to derive from the output of data group identification manager 108, data segmenter 112, and data stream network identification manager 116, values for one or more attributes associated with data stream source 104, and thereby create a data configuration profile of data stream source 104 including such attributes and their values. Examples of attributes that are associated with a data stream source include:
the data stream source's hardware type, age, and other predefined attributes, affiliations, location and personality, role, and place within an organization;
identities of communities and work-groups with which the data stream source is associated;
distribution of the data stream source's data streams that are associated with different data groups;
distributions of different types of network connections, responsiveness of the data stream source to communications from other data stream sources, and network centrality of the data stream source using any predefined centrality measure.

In one embodiment, attribute extractor 120 is configured to determine a combined value of the data stream source's attributes, which may include values related to attributes of the data stream source's network connections. For example, the combined value may include a value related to the data stream source's data streaming activity with regard to a certain data group combined with a value related to data streaming activity that the data stream source's neighbors in the data stream source's network have in that data group. In one embodiment attribute extractor 120 is configured to determine a confidence score associated with any attribute value. Below is an example of such a data configuration profile:
Data Source W: {Known Interacting Data Sources, Degree of Interaction: [<Data Source A, 0.5>, <Data Source F, 0.1>, <Data Source N, 0.2> . . . ], Data groups: [<Data Group 1, 0.2>, <Data Group 7, 0.5>, <Data Group 23, 0.1>], Responsiveness: High . . . . }

A data output stream manager 122 configures a data output stream to data stream source 104 in accordance with conventional techniques using any of the attributes and the derived attribute values in the data configuration profile of data stream source 104. For example, if the data configuration profile of Data Source W indicates a higher degree of interaction or affinity with Data Source A than with Data Source F, data output stream manager 122 configures a data output stream to data stream source 104 where Data Source A's communications are displayed more prominently on a computer display of Data Source W than are Data Source F's communications. This may be also be applied to social networks, where data configuration profiles of participants indicate affinity with other participants based on some measure of affinity, as well as values indicating the strength of an affinity.

Any of the elements shown in FIG. 1 are preferably implemented by one or more computers in computer hardware and/or in computer software embodied in a non-transitory, computer-readable medium in accordance with conventional techniques, such as where any of the elements shown in FIG. 1 are embodied in a computer (not shown).

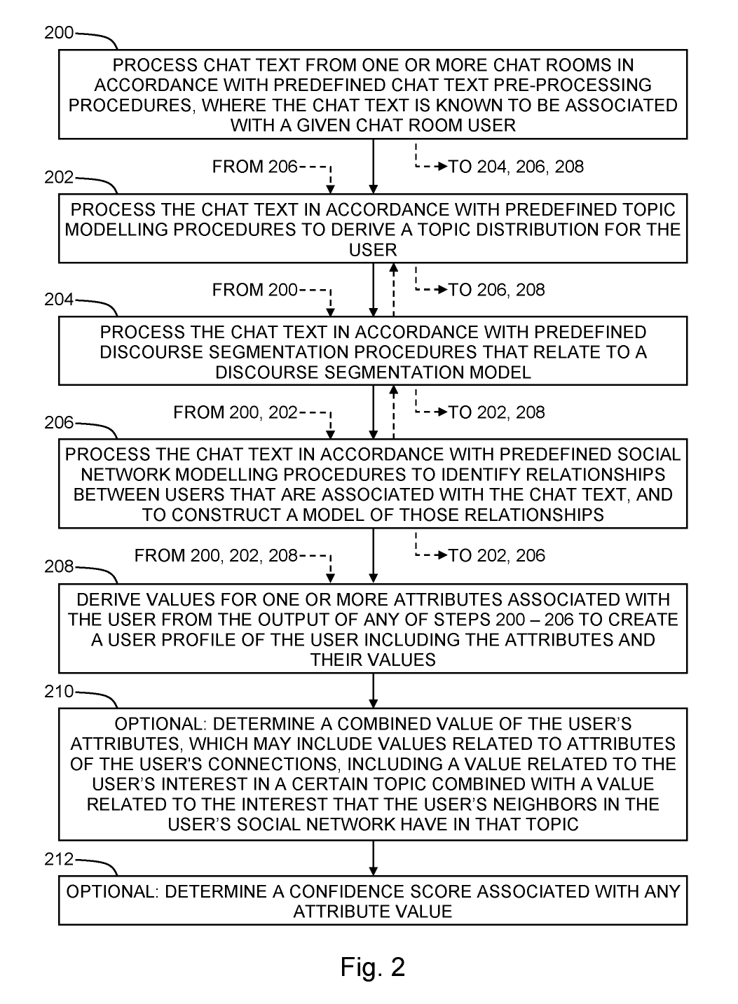

Reference is now made to FIG. 2, which is a simplified flowchart illustration of an exemplary method of operation of the system of FIG. 1, operative in accordance with an embodiment of the invention. In the method of FIG. 2, data from one or more data stream collators, where the data are known to be associated with a given data stream source, are processed in accordance with predefined data transformation procedures (step 200). The data are processed in accordance with predefined data group identification procedures to derive a data group distribution for the data stream source (step 202). The data are processed in accordance with predefined data segmentation procedures that relate to a data segmentation model (step 204). The data are processed in accordance with predefined data stream network identification procedures to identify network connections between data stream sources that are associated with the data, and to construct a model of those network connections (step 206). In various embodiments shown using dashed lines, any of steps 202, 204, and 206 receives as input, and is configured to process, the output of step 200, and/or the output of any of their counterpart steps. Values for one or more attributes associated with the data stream source are derived from the output of any of steps 200-206 to create a data configuration profile of the data stream source including the attributes and their values (step 208). Optionally, a combined value of the data stream source's attributes is determined, which may include values related to attributes of the data stream source's connections, including a value related to the data stream source's data streaming activity with regard to a certain data group combined with a value related to the data streaming activity that the data stream source's neighbors in the data stream source's network have in that data group (step 210). Optionally, a confidence score associated with any attribute value is determined (step 212). A data output stream to the data stream source is configured in accordance with conventional techniques using any of the attributes and the derived attribute values in the data configuration profile of the data stream source (step 214).

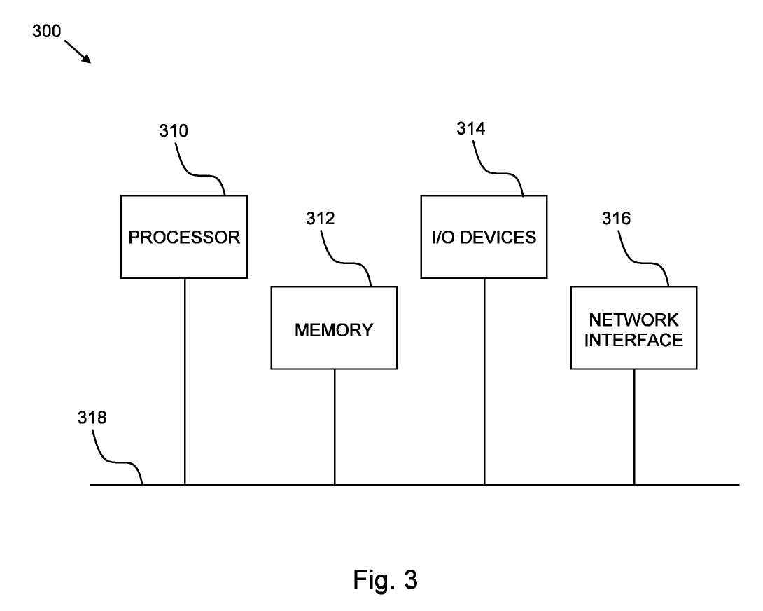

Referring now to FIG. 3, block diagram 300 illustrates an exemplary hardware implementation of a computing system in accordance with which one or more components/methodologies of the invention (e.g., components/methodologies described in the context of FIGS. 1-2) may be implemented, according to an embodiment of the invention. As shown, the invention may be implemented in accordance with a processor 310, a memory 312, I/O devices 314, and a network interface 316, coupled via a computer bus 318 or alternate connection arrangement.

It is to be appreciated that the term “processor” as used herein is intended to include any processing device, such as, for example, one that includes a CPU (central processing unit) and/or other processing circuitry. It is also to be understood that the term “processor” may refer to more than one processing device and that various elements associated with a processing device may be shared by other processing devices.

The term “memory” as used herein is intended to include memory associated with a processor or CPU, such as, for example, RAM, ROM, a fixed memory device (e.g., hard drive), a removable memory device (e.g., diskette), flash memory, etc. Such memory may be considered a computer readable storage medium.

In addition, the phrase “input/output devices” or “I/O devices” as used herein is intended to include, for example, one or more input devices (e.g., keyboard, mouse, scanner, etc.) for entering data to the processing unit, and/or one or more output devices (e.g., speaker, display, printer, etc.) for presenting results associated with the processing unit.

Embodiments of the invention may include a system, a method, and/or a computer program product. The computer program product may include a computer readable storage medium (or media) having computer readable program instructions thereon for causing a processor to carry out aspects of the invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the data stream source's computer, partly on the data stream source's computer, as a stand-alone software package, partly on the data stream source's computer and partly on a remote computer or entirely on the remote computer or server. In the latter scenario, the remote computer may be connected to the data stream source's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the invention.

Aspects of the invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for configuring a data output stream based on combined multi-source data streams, the method comprising:
in a step a), processing combined multi-source data stream data from one or more data stream collators in accordance with predefined data transformation procedures, wherein the data are known to be associated with a given data stream source;
in a step b), processing the combined multi-source data stream data in accordance with predefined data group identification procedures to derive a data group distribution for the given data stream source;
in a step c), processing the combined multi-source data stream data in accordance with predefined data segmentation procedures that relate to a data segmentation model;
in a step d), processing the combined multi-source data stream data in accordance with predefined data stream network identification procedures to identify network connections between data stream sources that are associated with the combined multi-source data stream data, and to construct a data stream source network model;
in a step e), deriving, from output of any of steps b), c), and d), values for one or more attributes associated with the data stream source; and
configuring a data output stream to the data stream source in accordance with any of the attributes and the derived attribute values associated with the data stream source.

2. The method according to claim 1 wherein any of steps b), c), and d) receives as input, and is configured to process, output of any of steps a), b), c), and d).

3. The method according to claim 1 and further comprising determining a combined value of the attributes, wherein the combined value includes values related to attributes of the data stream source's connections.

4. The method according to claim 3 wherein the combined value includes a value related to the data stream source's interest in a data group combined with a value related to the interest that the data stream source's neighbors in the data stream source's network have in that data group.

5. The method according to claim 1 and further comprising determining a confidence score associated with any of the derived attribute values.

6. The method according to claim 1 wherein any of the steps are implemented in any of
a) computer hardware, and
b) computer software embodied in a non-transitory, computer-readable medium.

7. A system for configuring a data output stream based on combined multi-source data streams, the system comprising:
a data pre-processor configured to process data from one or more data stream collators in accordance with predefined data pre-processing procedures, wherein the data are known to be associated with a given data stream source;
a data group identification manager configured to process the data in accordance with predefined data group identification procedures to derive a data group distribution for the data stream source;
a data segmenter configured to process the data in accordance with predefined data segmentation procedures that relate to a data segmentation model;
a data stream network identification manager configured to process the data in accordance with predefined data stream network identification procedures to identify network connections between data stream sources that are associated with the data, and to construct a model of the network connections;
an attribute extractor configured to derive, from output of any of the data pre-processor, the data group identification manager, the data segmenter, and the data stream network identification manager, values for one or more attributes associated with the data stream source; and
a data output stream manager configured to configure a data output stream to the data stream source in accordance with any of the attributes and the derived attribute values associated with the data stream source.

8. The system according to claim 7 wherein any of the data group identification manager, the data segmenter, and the data stream network identification manager, receives as input, and is configured to process, output of any of the data pre-processor, the data group identification manager, the data segmenter, and the data stream network identification manager.

9. The system according to claim 7 wherein the attribute extractor is configured to determine a combined value of the attributes, wherein the combined value includes values related to attributes of the data stream source's connections.

10. The system according to claim 9 wherein the combined value includes a value related to the data stream source's interest in a data group combined with a value related to the interest that the data stream source's neighbors in the data stream source's network have in that data group.

11. The system according to claim 7 and further comprising determining a confidence score associated with any of the derived attribute values.

12. The system according to claim 7 wherein any of the data pre-processor, the data group identification manager, the data segmenter, and the data stream network identification manager, are implemented in any of
a) computer hardware, and
b) computer software embodied in a non-transitory, computer-readable medium.

13. A computer program product for configuring a data output stream based on combined multi-source data streams, the computer program product comprising:
a non-transitory, computer-readable storage medium; and
computer-readable program code embodied in the storage medium, wherein the computer-readable program code is configured to
process, in a step a), data from one or more data stream collators in accordance with predefined data pre-processing procedures, wherein the data are known to be associated with a given data stream source,
process, in a step b), the data in accordance with predefined data group identification procedures to derive a data group distribution for the data stream source,
process, in a step c), the data in accordance with predefined data segmentation procedures that relate to a data segmentation model,
process, in a step d), the data in accordance with predefined data stream network identification procedures to identify network connections between data stream sources that are associated with the data, and to construct a model of the network connections,
derive, in a step e), from output of any of steps b), c), and d), values for one or more attributes associated with the data stream source, and
configure a data output stream to the data stream source in accordance with any of the attributes and the derived attribute values associated with the data stream source.

14. The computer program product according to claim 13 wherein the computer-readable program code is configured to receive as input at any of steps b), c), and d), and is configured to process, output of any of steps a), b), c), and d).

15. The computer program product according to claim 13 wherein the computer-readable program code is configured to determine a combined value of the attributes, wherein the combined value includes values related to attributes of the data stream source's connections.

16. The computer program product according to claim 15 wherein the combined value includes a value related to the data stream source's interest in a data group combined with a value related to the interest that the data stream source's neighbors in the data stream source's network have in that data group.

17. The computer program product according to claim 13 wherein the computer-readable program code is configured to determine a confidence score associated with any of the derived attribute values.
